(19) United States
(12) Patent Application Publication
(10) Pub. No.: US 2018/0015872 A1
(43) Pub. Date: Jan. 18, 2018

(54) Thermoluminescent Tire Safety Indicator Structure

(71) Applicant: Wen-Tse Huang, Kaohsiung City (TW)

(72) Inventor: Wen-Tse Huang, Kaohsiung City (TW)

(21) Appl. No.: 15/298,269

(22) Filed: Oct. 20, 2016

(30) Foreign Application Priority Data
Jul. 15, 2016 (TW) 105210633

(51) Int. Cl. B60Q 1/32; G01K 11/20; B60C 23/20; G09F 13/20

(52) U.S. Cl. CPC B60Q 1/326; G09F 13/20; G01K 11/20; B60C 23/20; B60B 2900/572; B60B 2900/571

(57) ABSTRACT

A thermoluminescent tire safety indicator structure includes a vehicle wheel and at least one luminescent indicator. The vehicle wheel includes a tire and a wheel disk. The luminescent indicator includes a styling pattern formed on the tire and/or the wheel disk and a thermoluminescent coating layer provided on the styling pattern. The thermoluminescent coating layer includes compounds with nano-scale thermoluminescent crystals and thermosetting polyester resins. The thermoluminescent coating layer on the vehicle wheel fluoresces for aesthetics as well as safety and warning effects when temperature on the tire and/or the wheel disk of a running vehicle increases.

### BACKGROUND OF THE INVENTION

### 1. Field of the Invention

The present invention relates to a luminescent warning structure, more particularly, to a tire safety indicator structure including a thermoluminescent coating layer on a vehicle wheel of an automobile, a motorbike or a bicycle for traffic safety.

### 2. Description of the Related Art

For warning and safety purposes, some materials or components such as reflective paints, reflective sheets, fluorescent paints or indicators have been used on ordinary vehicles frequently. In this regard, reflective paints including reflective materials function as reflective warning signs when light is projected on the paints. However, the reflective paints, which work when they are illuminated by an extraneous light resource, are limited to some applications. The drawbacks of reflective paints recur in reflective sheets. The fluorescent paints include light-induced energy storage materials in which energy of light projected on the materials awhile can be stored, fluorescing with no other light resource existing. However, with no energy stored inside in advance, the fluorescent paints fail to give out fluorescence and are limited to some applications because of weak fluorescence not lasting a long period.

As luminous components, the indicators such as bulbs and LED lamps, which generate visible light with operating voltage supplied externally, work well as warning devices but include delicate electronic components consuming more energy for illumination and violating environmental benefits.

### BRIEF SUMMARY OF THE INVENTION

Thus, an objective of the present invention is to provide a thermoluminescent tire safety indicator structure which gives out fluorescence at a vehicle wheel for a simplified structure as well as safety and warning effects with neither additional electricity nor extraneous light resources supplied.

To achieve this and other objectives, a thermoluminescent tire safety indicator structure of the present invention includes a vehicle wheel and at least one luminescent indicator. The vehicle wheel includes a tire and a wheel disk. The luminescent indicator includes a styling pattern formed on the tire and/or the wheel disk and includes a thermoluminescent coating layer on the styling pattern. The thermoluminescent coating layer fluoresces for aesthetics as well as safety and warning effects when temperature on the tire and/or the wheel disk of a running vehicle increases.

In a preferred form, the styling pattern is a graphic pattern or words, and the styling pattern is kept under or above a surface of the tire and/or a surface of the wheel disk. The thermoluminescent coating layer includes compounds with nano-scale thermoluminescent crystals and thermosetting polyester resins.

The thermoluminescent tire safety indicator structure of the present invention is characteristic of a simplified structure, low cost, unlimited applications, energy efficiency, and an environment-friendly material for a luminescent warning effect with neither extraneous light resources nor additional electricity supplied.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 is a perspective view of a thermoluminescent tire safety indicator structure in an embodiment of the present invention.

FIG. 2 is a partial, enlarged sectional view illustrating the thermoluminescent tire safety indicator structure of FIG. 1.

FIG. 3 is a schematic view illustrating a thermoluminescent tire safety indicator structure in another embodiment of the present invention.

### DETAILED DESCRIPTION OF THE INVENTION

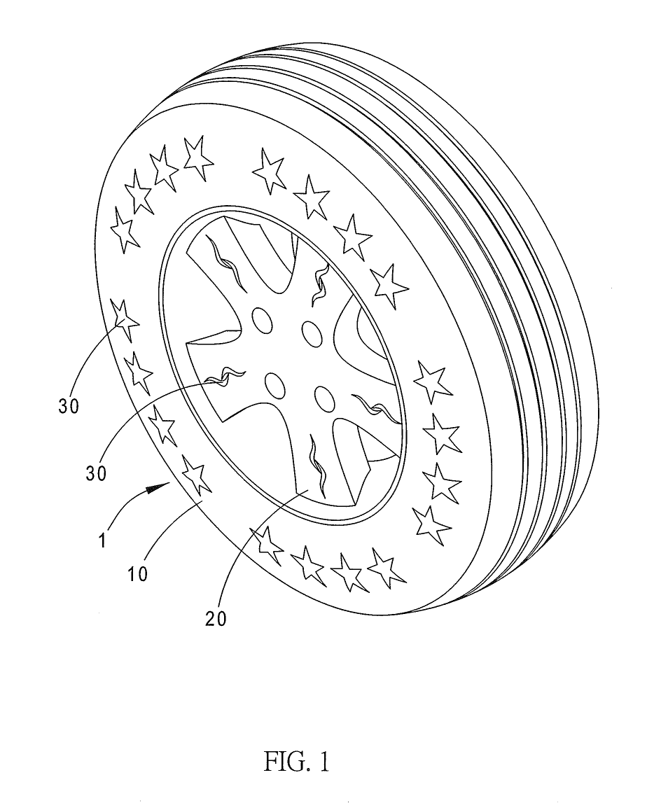

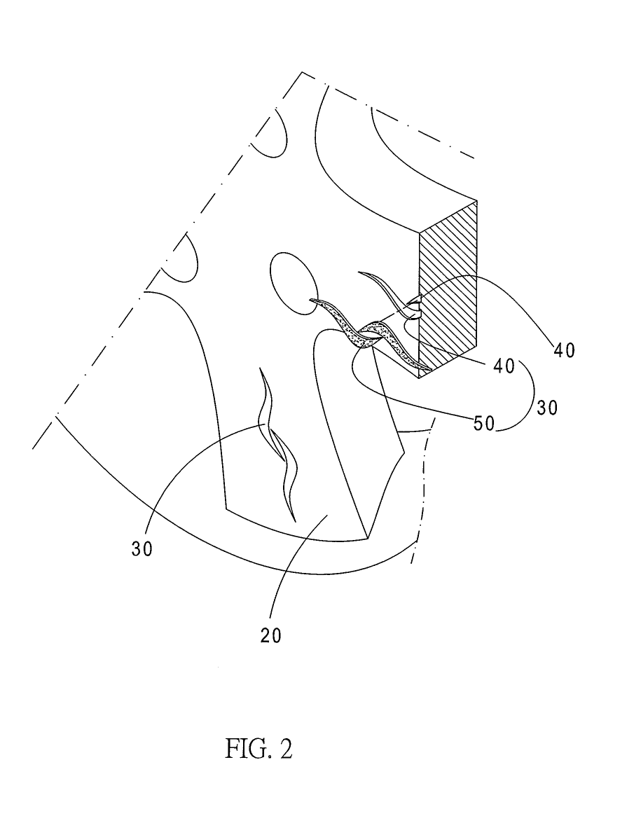

A thermoluminescent tire safety indicator structure according to an embodiment of the present invention is shown in FIGS. 1 and 2 of the drawings and generally includes a vehicle wheel 1 and at least one luminescent indicator 30. In this embodiment, the vehicle wheel 1 is a car wheel including a tire 10 and a wheel disk 20. The at least one luminescent indicator 30 is provided on the tire 10 and/or the wheel disk 20. In this embodiment, a plurality of luminescent indicators 30 are provided on surfaces of the tire 10 and the wheel disk 20.

Each luminescent indicator 30 includes a styling pattern 40 and a thermoluminescent coating layer 50 on the styling pattern 40. The styling pattern 40 developed on the tire 10 and/or the wheel disk 20 can be a graphic pattern, words, or a trade mark. In this embodiment, each styling pattern 40 is a groove formed in the surfaces of the tire 10 and the wheel disk 20. The thermoluminescent coating layer 50 is a layer of coating paints in which nano-scale thermoluminescent crystals are incorporated. The phenomenon of thermoluminescence denotes luminescence is getting strong gradually and kept projective from specific luminescent substances to which no light ray but constant heat is provided. The luminescent substances may include lead tungstate crystals or quartz crystals. The thermoluminescent crystals are processed to be nano-scale substances for strengthened photo-absorption and light reflectivity, less energy loss during light transmission, and better luminescent efficiency of the thermoluminescent substances.

In this embodiment, the thermoluminescent coating layer 50, which is manufactured with nano-scale thermoluminescent crystals and thermosetting polyester resins mixed, is coated on and adheres to the styling pattern 40 securely. In a feasible embodiment, the thermoluminescent coating layer 50 is kept above/under or leveled with the surface of the tire 10 or the wheel disk 20 for convex/concave or planar visual aesthetics. Alternatively, the thermoluminescent coating layer 50 is applied on raised styling patterns 40 and highlights a three-dimensional effect of the luminescent indicator 30.

In practice, the thermoluminescent tire safety indicator structure of the present invention works properly when heat generated by rolling tires of a moving car on the ground and running mechanical components causes higher temperatures on the tire and/or the wheel disk of the vehicle wheel. The heat enables nano-scale thermoluminescent crystals in the thermoluminescent coating layer 50 to fluoresce by themselves. Thus, striking luminescence from the luminescent indicators 30 strengthens a warning effect and a car driver's safety with neither light reflection nor extra electrical power required. Moreover, the thermoluminescent tire safety indicator structure of the present invention is characteristic of a simplified structure, low cost, unlimited applications, energy efficiency, and an environment-friendly material in contrast to conventional reflective warning structures which are enabled while reflecting light projected from outside or generated by external electrical power.

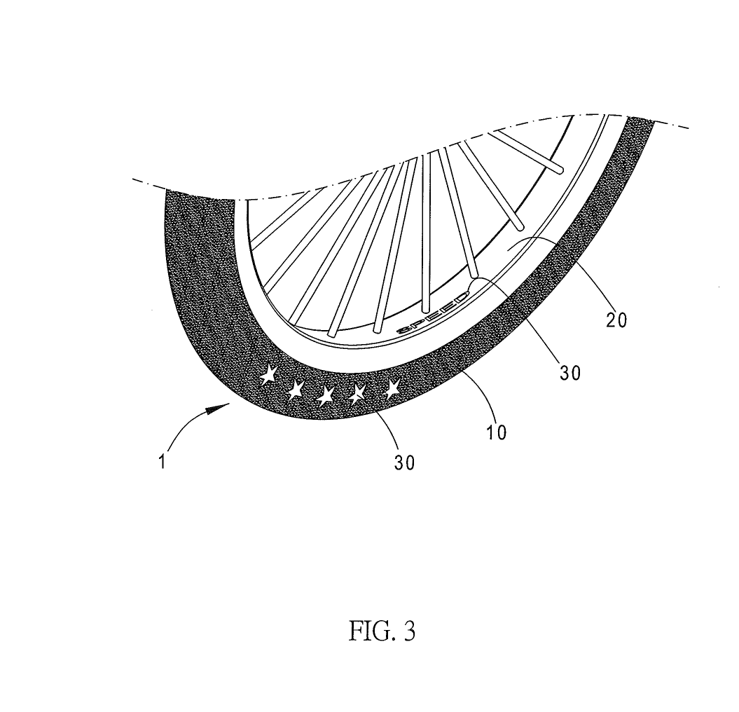

FIG. 3 illustrates a thermoluminescent tire safety indicator structure in another embodiment of the present invention applied to an ordinary bike's vehicle wheel 1. A luminescent indicator 30 of the thermoluminescent tire safety indicator structure is provided on a tire 10 and/or a wheel disk 20 of the vehicle wheel 1 of the bike, which is short of safety indication function, for cycling safety.

The scope of the invention is to be indicated by the appended claims, rather than by the foregoing description, and all changes which come within the meaning and range of equivalency of the claims are intended to be embraced therein.

1. A thermoluminescent tire safety indicator structure comprising:
a vehicle wheel including a tire and a wheel disk; and
at least one luminescent indicator including a styling pattern formed on the tire and/or the wheel disk, with the at least one luminescent indicator further including a thermoluminescent coating layer provided on the styling pattern.

2. The thermoluminescent tire safety indicator structure according to claim 1, wherein the styling pattern is a graphic pattern or words, with the styling pattern kept under or above a surface of the tire and/or a surface of the wheel disk.

3. The thermoluminescent tire safety indicator structure according to claim 1, wherein the thermoluminescent coating layer includes compounds with nano-scale thermoluminescent crystals and thermosetting polyester resins.
